(19) United States
(12) Patent Application Publication
(10) Pub. No.: US 2005/0219526 A1
(43) Pub. Date: Oct. 6, 2005

(54) Method and apparatus for monitoring biological substance

(76) Inventor: Hong Peng, Fremont, CA (US)

Correspondence Address: HONG PENG, 42874 VIA NAVARRA, FREMONT, CA, 94539, US

(21) Appl. No.: 10/761,943

(22) Filed: Jan. 20, 2004

Related U.S. Application Data
(60) Provisional application No. 60/440,876, filed on Jan. 17, 2003.
(60) Provisional application No. 60/480,824, filed on Jun. 23, 2003.

(51) Int. Cl. G01N 21/00

(52) U.S. Cl. 356/338

(57) ABSTRACT

A disclosed apparatus and method provide a wide range, real-time and on-line continuous detection for a biological substance concentration by monitoring the turbidity of the biological fluid medium in a transparent container with techniques that suppressing ambient light, non-uniform concentration distribution, bubble and interface scattering effects in a dynamic environment.

This patent application is entitled to the benefit of two Provisional Patent Applications: 60/440876, filed on Jan. 17, 2003, and 60/480824, filed on Jun. 23, 2003.

### BACKGROUND OF THE INVENTION

Biological culture is an important bioprocess for microorganism and cell growth. The growth curve of microorganisms (bacteria, yeast, or fungi) and cells (human, animal, or insect cells) demonstrates the effect of environmental chemicals, pH, temperature, and other parameters and endogenous factors on the corresponding microorganisms and cells. Real-time and on-line monitoring a kinetic biological culture, especially in a dynamic environment, is extremely valuable in a variety of fields including biotechnology, pharmaceutics, clinical medicine, agriculture and food industry.

Existing biological culture equipments range from simple incubators, incubator shakers, or shakers to sophisticated and expensive bioreactors. Among them, the incubator/shakers for small to medium volume (10 ml˜1000 ml) biological culture containers like flasks are the most widely used equipments. Here the term incubator/shakers refer to incubators, incubator shakers or shakers. This conventional culture method has been used for many many years. However, so far, there is no an on-line detection system being developed for monitoring the growth curve of biological culture with such equipments.

The concentration of biological substance such as microorganisms and cells is one of direct indicators for the biological culture status, apart from pH, dissolved oxygen and dissolved carbon dioxide. The two most common techniques of measuring the concentration, particular for microorganisms and cells, are spectrophotometery and hemocytometry. The spectrophotometer technique is to detect the optical density (OD) of biological media and the hemocytometer technique is to count the biological substance number in a diluted biological medium.

The principle of spectrophotometer is simple: the intensity of the light which is transmitted through a biological medium containing an absorbing and scattering substance like microorganism, cells and proteins is decreased by that fraction which is absorbed and scattered, and this fraction can be detected and measured photo-electrically. This kind of optical density measurement is also called turbidity measurement.

Generally, there are two kinds of concentration measurement with a spectrophotometer. First one is to utilize a special cuvette or a test tube with a small volume (about 1 ml). To perform such conventional measurement for a growing biological substance like microorganism in a flask, it usually requires withdrawing a small sample from the biological medium and putting the sample in a cuvette or a test tube for a spectrophotometer measurement. This kind of measurement is discrete and can cause a disruption for biologic culture.

The second is to utilize a stick-shape detecting probe with a light emitter and a light sensor or optical fibers built in the probe. Although this kind of spectrophotometer can perform continuous measurement, it is still very difficult for this kind of spectrophotometers to measure a biological medium in a shaking environment. The measurement requires submerging the probe in a biological medium and sterilization is always required.

These existing measurements become very tedious and even impossible when a real-time and on-line continuous concentration measurement is required especially when biological substance is in growing and shaking environment, such as microorganism and cell culture in an incubator/shaker. However a real-time, on-line and automatic measurement of biological substance concentration in an incubator/shaker will allow culture process to be very efficient and productive and can solve logistic problems and save time and efforts for biologists.

### SUMMERY OF THE INVENTION

The object of this invention is to provide an apparatus and method for a wide range, real-time and on-line monitoring biological substance concentration in a biological culture environment, especially when the biological culture such as microorganism and cell culture happens in a regular liquid medium container like a flask in an incubator/shaker other than a bioreactor.

Another object of this invention is to innovate existing incubator/shakers by embedding a concentration measurement device that can perform a wide range, real-time and on-line monitoring of a biological culture medium without using a submersible probe or withdrawing a small amount of the medium sample from the biological culture for measurement. Furthermore, the biological culture rate can be altered purposely by controlling and regulating culture environment parameters such as the temperature or shaking speed of the incubator/shaker.

The present invention can achieve above objects by utilizing a probe that detecting the turbidity of the biological culture medium in a transparent medium container from the outside of the container. A microprocessor is used to perform digital data processing to overcome signal fluctuation problems caused mainly by ambient light, non-uniform density distribution, bubble and air-medium interface scattering effects.

### BRIEF DESCRIPTION OF THE DRAWINGS

FIG. 1a A scattering turbidity probe for detecting scattering light from an area in a biological medium. The area is at the path of transmission light from the probe light source. The scattered light path is not the same as that of the incident light.

FIG. 1b A schematic diagram of back scattering turbidity probe. The scattered light path is the same as that of the incident light.

FIGS. 2a & 2b A schematic diagram of a transmission and scattering probe used for a typical flask.

FIGS. 3a, 3b, 3c & 3d A schematic diagram of a practical scattering probe used for a typical Erlenmeyer flask.

FIGS. 4a & 4b A schematic diagram of a practical scattering probe with a clamp for a typical flask

FIG. 5 A diagram illustrating a position arrangement among a probe, a flask clamp and a flask.

FIG. 6 A schematic diagram of a practical scattering probe used for a typical flask.

FIG. 7 A block diagram of a electronic scheme for probe

FIG. 8 A schematic diagram of a scattering turbidity monitoring system using a computer.

FIG. 9 A schematic diagram of a scattering turbidity monitoring system with multiple detecting probes.

FIG. 10 A schematic diagram of an incubator/shaker with a built-in turbidity monitoring system.

FIG. 11 A schematic diagram of a differential detection scheme.

FIG. 12 A typical scattering turbidity monitoring system using a microprocessor.

FIG. 13 A block diagram of a typical signal and data processing system for a dynamic turbidity monitoring system.

### DESCRIPTION OF THE INVENTION

This invention presents an apparatus and method that providing a wide range, real-time and on-line continuous detection of the turbidity of a biological medium directly in a transparent container without submerging a probe in the medium or withdrawing a small medium sample from the container. The container can be a regular flask, a beaker, a bottle or a specially designed container. The container can be made from glass, crystal or plastics.

One of key features of this invention is to utilize a scattering technique. The most common method of measuring the turbidity of a biological medium is to utilize a transmission spectrophotometer. However the turbidity can also be measured using a scattering method. When light transmits through a biological medium containing a biological substance such as microorganism, cells, DNA or protein, the light can be mostly scattered other than absorbed. The scattered light intensity also depends on the concentration of biological media. It should be noted that the scattering and absorption properties of the biological media could also depend on other factors such as light wavelength, biological substance size, color, and refractive index. The spatial distribution of the scattered light intensity also depends on the properties of biological media.

For a simple case, assuming light scatters uniformly to any angle direction and the light is mostly scattered other than absorbed, based on the inverse of Beer-Lambert law, the scattered light intensity from a point on its light path is proportional to the density of a biological medium and input light intensity at that point. If the input light intensity at that point is constant, the scattered light intensity is proportional to the density at that point. So it is easy to understand that the entry place for the light entering a biological medium is an area to have such simple density-proportional property for the scattering light if the light source is constant. However other area will have multi-scattering issues.

Therefore the scattering method can make a measurement with a large volume container possible and it also can make a linear measurement to a high concentration comparing to transmission technique. However the linear relation between the scattering light intensity and the concentration will change when the concentration becomes very high and multiple scattering can't be ignored.

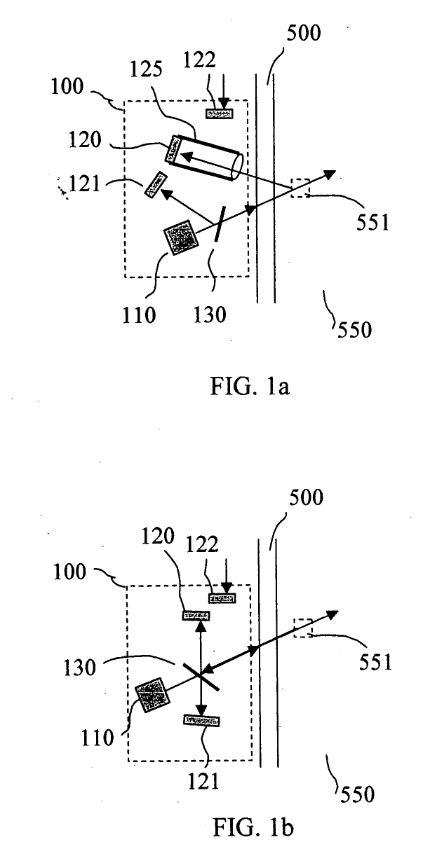

In the first embodiment, a basic probe 100 based on the scattering technique is schematically shown in FIGS. 1a & lb. The probe includes a light source 110 (or multiple light sources) and a photodetector 120 (or multiple photodetectors) such as a photodiode, a phototransistor or a photoconductive cell (CdS). The source 110 can be a monochromic source like a semiconductor laser source, Light Emission Diode (LED) or a non-monochromic source like ordinary flash lamp, tungsten lamp and broadband LED. The source 110 can be in UV, visible or NIR wavelength. The detector 120 is to detect the scattered light from a medium 550 through a transparent wall of a biological medium container 500 when the light source 110 emits light on the medium 550. Medium 550 can be a biological medium, a chemical solution or wastewater. The medium container 500 can be a typical flask, beaker or bottle with a small, medium or large volume. For the monochromic source, the photodetector 120 can have a light filter with it to mainly detect the probe source light other than all background light. In a typical case as shown in FIG. 1a, the incident light path and the scattered light path are different. The photodetector 120 is arranged near the light source 110 in the probe 100 and the probe 100 is attached to or mounted on the out surface of a medium container such as a flask, a beaker or a bottle. The photodetector 120 is aimed or focused to detect the scattering light from the area 551 that is close to the entry position of light in the medium. In another typical case as shown in FIG. 1b, the incident light path and the scattered light path are the same. A light splitter 130 reflects the scattered light to photodetector 120. In other cases, the photodetector 120 can be arranged in any position that is not close to source 110 to detect scattering light from any scattering area in medium 550.

In the first embodiment as shown in FIG. 1a, the probe 100 basically consists of at least one light source 110 and at least one photodetector 120. One reference photodetector 121 can detect the light intensity drift of source 110. The detector 121 is to measure a part of output light intensity from the source 110 using a light splitter 130. Other reference photodetector 122 can be used to detect the ambient background light intensity. The signals from the reference photodetectors 121 and 122 can be used to correct the drift of the light source 110 and outside background (ambient) light change.

In the first embodiment, to reduce the ambient light influence and other noises, a narrow incident light beam and a narrow scattering detection angle are required. For light sources 110, a narrow light beam can be formed using a light tube guide, parabolic mirror or a lens. In FIG. 1a, the photodetector 120 is constructed with narrow detection angular characteristics so that it can only detect a target area 551 at the light path of source 110. In one option, a simple light tube guide 125 can help photodetector 120 aim to the area 551 and narrow the detection angle.

In the first embodiment, splitter 130 and photodetector 121 & 122 are optional. If a stable light source 110 is used, probe 100 can be constructed without reference photodetector 121 and light splitter 130. If the probe 100 is designed for detection in an environment with a stable ambient light intensity, reference photodetector 122 may not be required.

In the first embodiment, probe 100 can be made as a small size device that only connected to its signal-processing module through an electrical cable. The miniaturized probe 100 allows it to be easily embedded on the shaking platform of an incubator/shaker. This makes it possible to measure real-time turbidity of a biological medium when the container is under a shaking condition. To miniaturize probe 100, probe 100 can only have necessary electrical circuit components such as pre-amplifiers.

In the first embodiment, off-line calibration is a process to let the probe 100 and its post signal processing device give comparable and standardized measurement values for medium turbidity. The calibration is carried out by measuring the turbidity of standardized reference media in a medium container 500. The reference media should have stable turbidity with known OD numbers that are measured by a standard spectrophotometer. The reference medium can be the same medium with different values of OD so that two-point or multiple-point calibration can be performed. The reference medium can be a primary standard medium: Formazin.

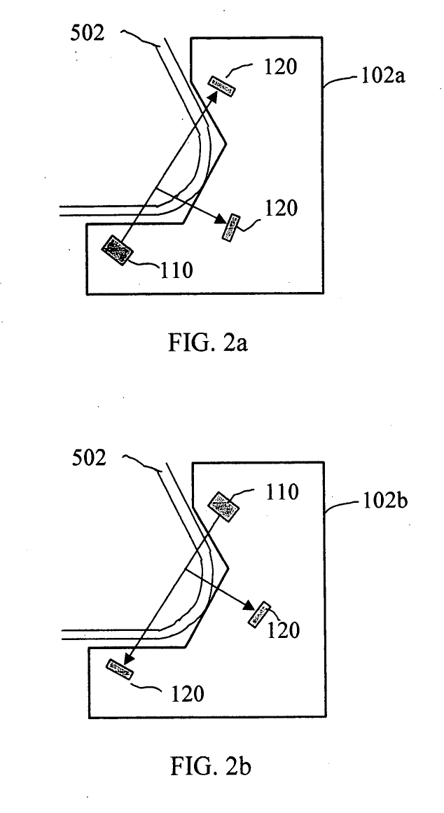

In the second embodiment, both transmission technique and scattering technique that presented in the first embodiment are used for a practical case. As shown schematically in FIG. 2a & 2b, probe 102a and 102b are designed for a typical flask 502. A probe 102a or 102b mainly consists of a light source 110, a photo detector 120 that detecting transmitted light and another photo detector 120 that detecting scattered light. To fit flask 502 well with probe 102a or 102b, the size and shape of flask 502 should be standardized. Probe 102a or 102b can have different sizes to adapt to standardized flasks with different size and volumes such as 125 ml, 250 ml, 500 ml, 1 L, 2 L and 3 L. The important feature of this embodiment is to utilize the bottom corner of a typical flask. Light source 110 can be arranged either below flask 502 as shown in FIG. 2a or above the flask corner as shown in FIG. 2b. In this embodiment, a specially constructed flask with an even smaller round corner can be one alternative. The advantage of this embodiment is to make probe 102a or 102b capable of self-calibration. The OD measurement from transmission detector can be used to calibrate the scattering detector. In case there is a specially designed medium container that has an extra cuvette formed around its bottom, only a transmission probe is needed to perform a turbidity measurement.

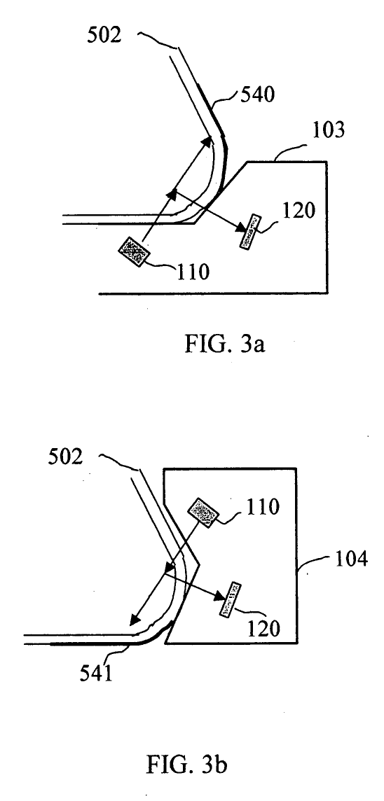

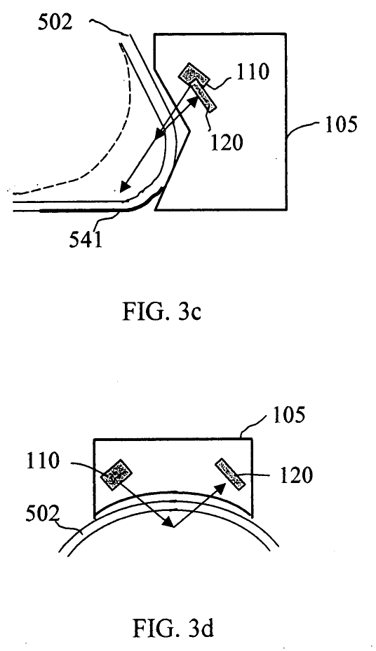

In the third embodiment, only scattering technique is used. As schematically shown in FIGS. 3a, 3b, 3c & 3d, probe 103, 104 and 105 are designed for a typical flask 502. Probe 103, 104 or 105 is a variation of probe 100 for taking the advantages of the corner part of a media container like that of a flask. To fit flask 502 well with probe 103, 104 or 105, the size and shape of flask 502 and probe 103, 104 and 105 should also be standardized. Probe 103, 104 and 105 can have different sizes to adapt to standardized flasks with different size and volumes such as 125 ml, 250 ml, 500 ml, 1 L, 2 L and 3 L. The important feature of this embodiment is also to utilize the bottom corner of a typical flask. Light source 110 can be arranged either below flask 502 as shown in FIG. 3a or above the flask corner as shown in FIGS. 3b & 3c. In this embodiment, a specially constructed flask with a smaller round corner can be one alternative. To reduce the light reflection of transmitted light on the wall of flask 502, a light absorber 540 or 541 can be applied on the outside surface of flask 502 around the area close to the light path as shown in FIGS. 3a, 3b & 3c. A simple way of making the absorber is to paint the area with black color paint if a visible light source 110 is used.

In the second and third embodiments, arrangement of the probes 102a, 102b, 103, 104 and 105 around the corner of a flask is to avoid the light path of source 110 to pass through the interface between medium and air even the biological medium is under a shaking condition. This arrangement can significantly reduce the reflection influence from the air-medium interface in flask 502.

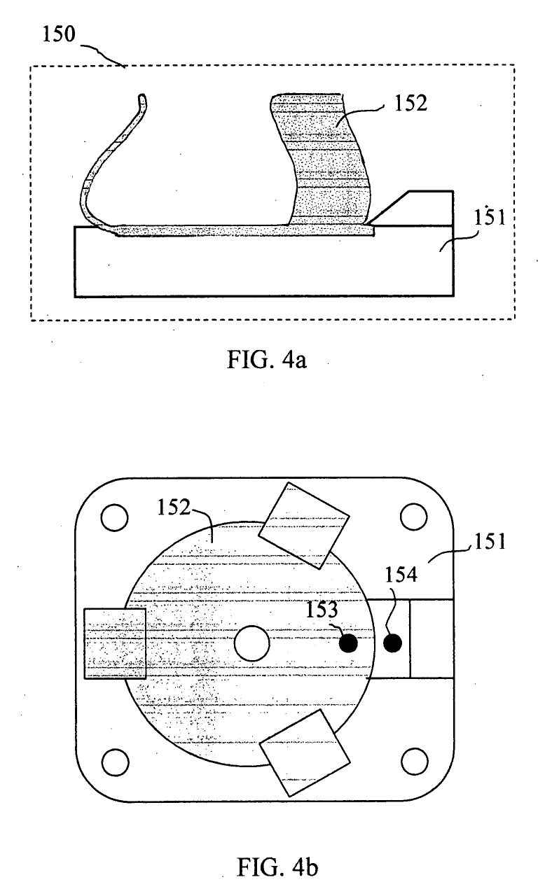

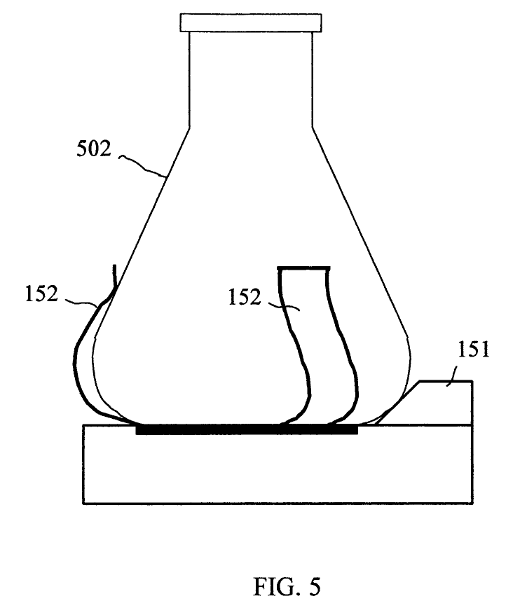

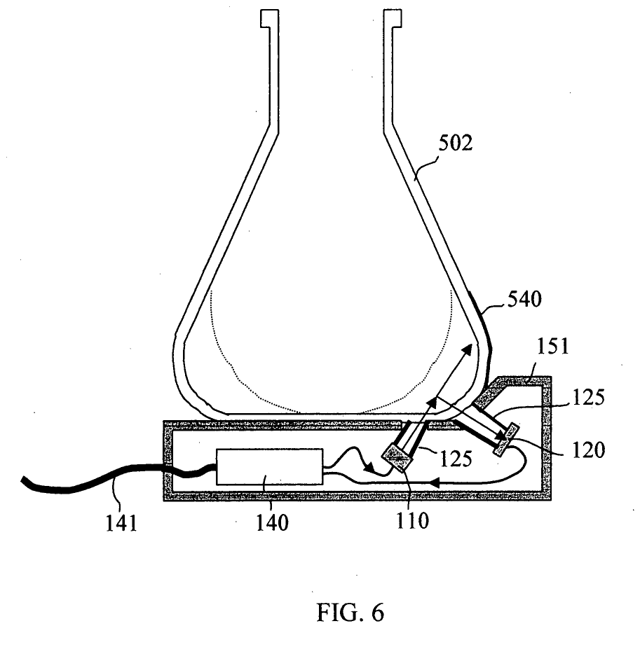

In the fourth embodiment, a practical probe 150 using scattering technique described in the fourth embodiment is presented. As shown schematically in FIGS. 4a, 4b, 5 and 6, the practical probe 150 comprises a probe base 151 and a flask clamp 152. Flask clamp 152 can be an existing commercially available product with a minor modification for probe 150. Flask clamp 152 can also be any design that can hold a flask firmly on base 151. Apart from supporting a flask 502, the probe base 151 is designed to house and support optical and electronic circuitry such as a light source 110, detector 120, light guide tube or hole 125 and electronic circuitry 140 as shown in FIG. 6. On base 151, there are two small holes. Hole 153 is constructed to aim the light beam with a designed incident angle. Hole 154 is constructed to allow a narrow detection angle for photo detector 110. In a typical case, the scattering detection is around a 90 degree angle to the incident light beam because this angle is considered very sensitive to light scattering. Clamp 152 can be mounted firmly on base 151 using screws. Base 151 is also designed to be able to attach to an incubator/shaker platform using screws. FIG. 5 shows one option of arrangement among a base 151, a clamp 152 and a flask 502. FIG. 6 schematically shows a cross section of a flask 502 and base 151. It shows that probe 150 also comprises at least one light source 110, at least one photo detector 120, electronic circuitry 140 and electrical wire 141. Circuitry 140 comprises a light source driver, a photodetector circuit and an amplifier. Probe 150 is designed to be able to detect the turbidity with minimum reflection interference from medium surface in flask 502 even when flask 502 is under a shaking condition. The dash line in flask 502 shows a typical air-medium interface curve under an orbital shaking condition.

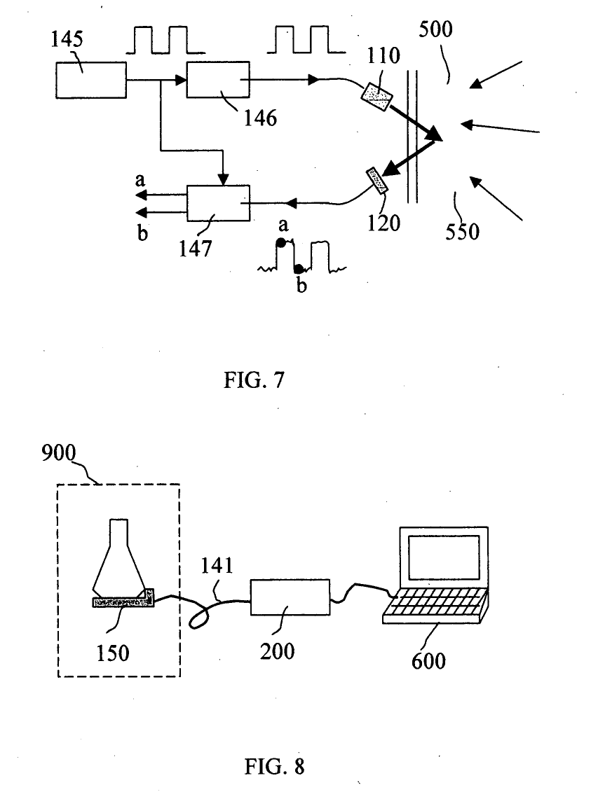

In the fifth embodiment, to correct the unwanted signal from ambient light source, an ambient light compensation scheme is shown schematically in FIG. 7. In this embodiment, a reference photodetector for ambient light detection is not required. However, the light emitted from source 110 is pulse regulated. One option is an on-off-on pulse signal. When the light is on, sensor 120 detects both scattered light and ambient light. When the light is off, the same sensor 120 detects only ambient light. The later signal can be used to compensate the former signal. Since these two signals are not detected at the same time, the compensation can only be effective when the ambient light change slowly and considered as a constant during an on-and-off period. This scheme could be realized by including a pulse generating circuit 145, light source driver 146 and a pulse gated signal detection circuit 147.

In the sixth embodiment, the detector system is designed to work with existing incubator/shakers. As shown in FIG. 8, this turbidity detector system is a single probe system that consists of a probe 150, a signal-processing module 200 and a computer 600. In this embodiment, probe 150 is just one option and any other probes above can replace probe 150. In this system, only probe 150 is mounted on or in an incubator/shaker 900. Signal processing module 200 can include an A/D converter, power supply for probe 150 and an I/O module for communication with a computer 600. Computer 600 performs real-time data processing and presents results. In this embodiment, multiple probes can be used with multiple input ports on module 200.

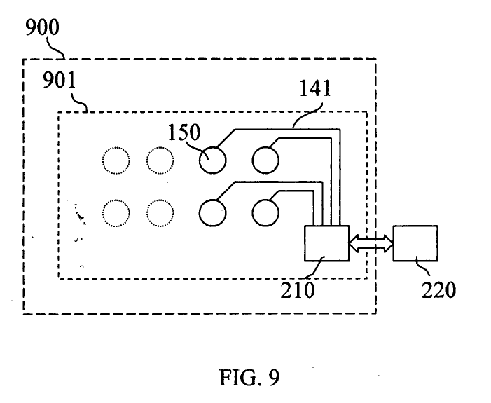

In the seventh embodiment, a biological medium turbidity monitoring system is shown in FIG. 9. It consists of multiple probes 150, cable 141, a signal relay module 210 and a signal and data processing module or device 220. Any other probes above can replace probe 150 in this embodiment. The signal relay module 210 and the signal and data-processing module 220 can have an option to be integrated into one device or remain as two spatially separated module. The module 210 is functional as a hub for multiple probes. It can perform functions such as signal amplification, signal conditioning, drift and background compensation, detection resetting, power supply and switching for probes. The module 220 includes an A/D converter, a micro-controller or a microprocessor, memory circuit, control circuitry for probes, an I/O module for communication with other instruments like a computer, manual input buttons and a result display panel. With a microprocessor and data storage IC, the module 220 can store instrument status data and the turbidity data of biological media including any calibration point data such as the beginning point of biological culture.

In the eighth embodiment, the multiple probes 150 will mounted in an incubator/shaker platform 901. As shown in FIG. 9, the signal relay module 210 will also be mounted on incubator/shaker platform 901 and the signal and data processing module 220 can be mounted inside or outside of the incubator/shaker 900. Because the module 210 is mounted on a shaking platform, it may just have some necessary circuitry such as amplifiers, drift and background compensation circuitry, switches and power supplies and leave other circuitry in the signal and data processing module 220. The signal relay module 210 can communicate with the signal-processing module 220 through a wire, a RF wireless or an infrared wireless method. A wireless method will allow the module 220 to be placed outside of the incubator/shaker 900 without a cable connection restriction. This method also eliminates a shaking cable connecting the module 210 and the module 220 if the module 210 is mounted on the shaking platform and the module 220 is not. So the shaking cable problem can be solved.

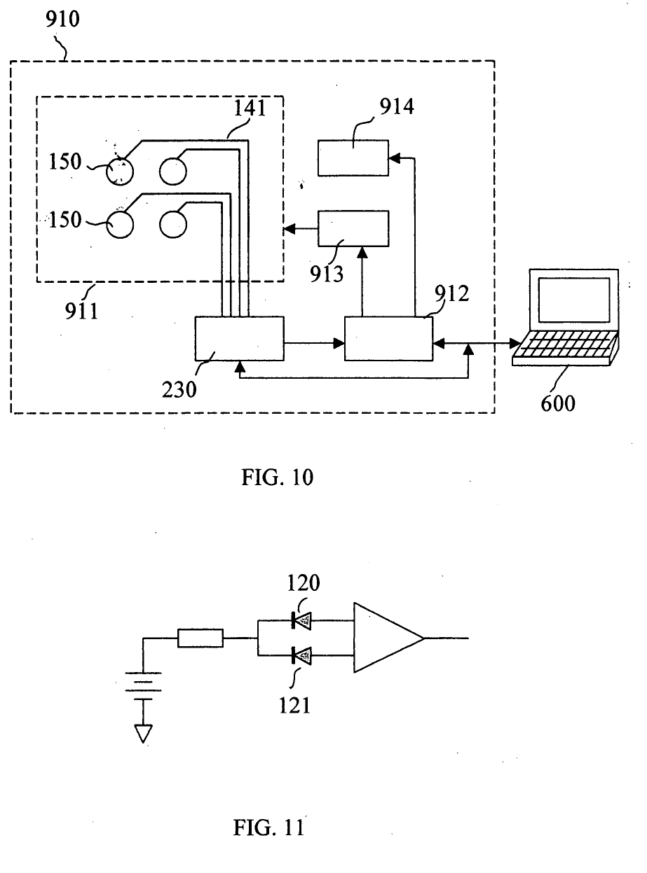

In the ninth embodiment, a biological medium turbidity monitoring system described in the seventh or eighth embodiment is not a standalone device from a biological culture incubator/shaker. The monitoring system is built in an incubator/shaker before the incubator/shaker rolls out from its manufacturer. So this embodiment is actually an innovation for an incubator/shaker based on the turbidity monitoring system. As shown schematically in FIG. 10, the probes 150 or other probes are built in incubator/shaker platform 911. The relay module 210 and signal-processing module 220 could be combined as one module 230. Module 230 is also built in the incubator/shaker 910 with a shaker electronic control module 912. Module 912 sends control signals to a shaker motor 913 and a temperature control module 914 to regulate the shaking speed and temperature of incubator/shaker 910 based on the turbidity measurements from module 230. Apart from communication between the monitoring system and shaker control module 912, both module 230 and 912 can communicate with other instruments like a computer 600 via RS-232, RS-485, USB, intranet or internet. The integration of a turbidity monitoring system and an incubator/shaker will enhance current incubator/shaker technology to a new level.

There are two critical problems regarding the accuracy and repeatability of the detect systems above. The first is the correlation among the biological medium concentration, transmittance measurement and scattering measurement. The second is the detection noise under a shaking condition.

The turbidity measurement does not equal concentration measurement. With transmittance OD (spectrophotometer) measurement, the concentration and measured OD value can have a linear relation when only OD value is not too low or not too high. To keep a linear measurement for a high OD medium with a spectrophotometer, a dilution technique has to be used. Therefore transmission spectrophotometers are still the most common tools to measure the density of biological media. However, scattering measurement can have wider linear range than that of transmittance measurement without using the dilution technique. Since the dilution technique can't be used for an on-line measurement, the scattering technique is very attractive for a wide range and on-line measurements. But this linear relation can't have unlimited range, especially for biological culture media. Because the scattering properties of some biological culture media become less linear relative to the concentration when the concentration is a very high. In addition, multiple scattering in high concentration media will have an effect on the scattering measurement. The scattering light intensity from a measurement area could increase when some light scattered from an adjacent area could pass the measurement area and be re-scattered again. So a calibration between the measured scattering intensity and the concentration is always required.

The measurement noise is a key problem for the scattering technique described above for a biological culture medium in a flask that is under a shaking condition. There are many noise sources such as detector electronic noise, thermal drift noise, ambient light noise and shaking medium noises. However the most critical noise is the shaking medium noise. The shaking medium noise comes from the bubbles in the medium, light reflection from shaking air-medium interface and scattering fluctuation due to concentration non-uniformity of a turbulent biological medium.

A differential detection scheme with a precision instrumentation amplifier as shown in FIG. 11 can reduce the detector electronic noise that including light source and sensor noise. This scheme also reduces the influence of thermal drift. Usually, a biological culture incubator/shaker is operated in a temperature-controlled environment and thermal drift is not an issue. However, if temperature is a variable as described in the ninth embodiment, a temperature compensated detector electronic scheme may be required. As for ambient light noise, there is a technique to reduce its influence. A flask mounted on a detecting probe could be clothed with a trumpet shape dark cover.

When a biological medium in a flask is under a shaking condition, the bubbles in the medium can cause a very sharp scattering light noise on a photodetector. Meanwhile the light reflection from the air-medium interface of a biological medium in the flask can cause a light intensity fluctuation on the photodetector. This light reflection depends on the arrangement of incident light beam and the flask, medium volume and shaking speed. The incident light and scattered light always has light reflection at the interface of different media such as between the flask glass and air, the flask glass and a biological medium. Usually if there is no light absorption, the reflected light will be travel to another interface and some part of it will be reflected again. This multiple reflection will form a light background in the biological medium and the space around even without ambient light. In all embodiments of this invention, one of key ideas is to fix the position of the probe with respect to a container that will reduce variables due to the light reflection. The dark cover can also be useful for this reason. Therefore the shaking air-medium interface will be only major cause for the light background fluctuation. It has been found that the influence of the light reflection background can be reduced with a high volume medium and a high shaking speed. The high volume medium increases the distance between the incident light path and the air-medium interface. The high shaking speed (>150 rpm) makes the air-medium interface more axially symmetric and less amplitude fluctuation.

The scattering fluctuation due to concentration non-uniformity of a turbulent biological medium becomes a most important noise when the density of the biological medium is high. The viscosity and mass density difference between biological substance and a culture medium (buffer) causes spatial non-uniform distribution of the biological substance in the biological medium when the medium is under a shaking condition such as an orbital shaking condition. This fluctuation at any location in the medium is also time dependent. A volatile cloud in the sky may be a good analog to this phenomenon. It has been found that this fluctuation strength increases as the density of biological medium increases.

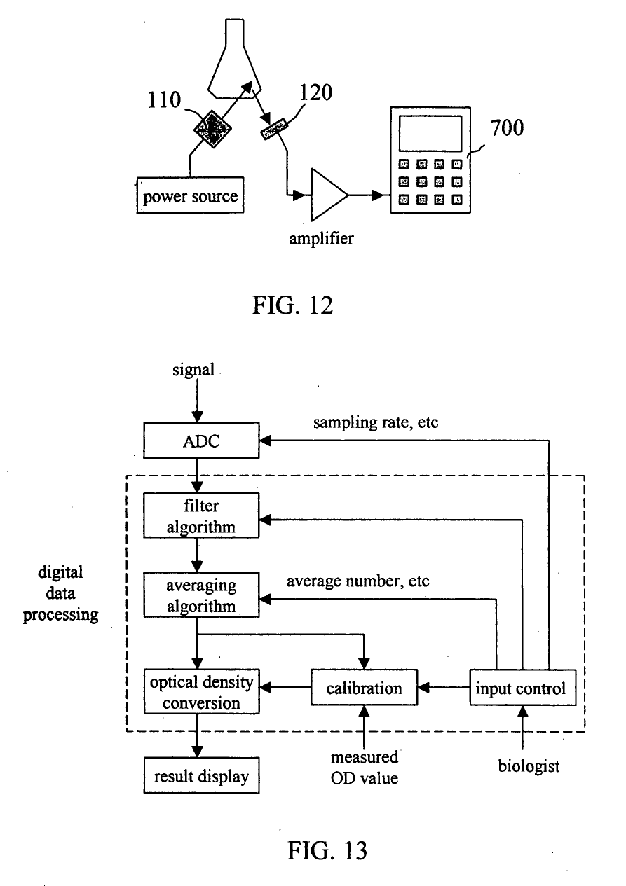

A microprocessor becomes indispensable in above monitoring system because of complexity of the noise problems, calibration and optical density conversion (linearization) problems. Since biological culture is a slow process, a microprocessor such as an embedded microprocessor or a computer can provide enough computing power to perform digital data processing for the monitoring system. FIG. 12 schematically shows a typical monitoring system including a user interface module 700 with a built-in embedded microprocessor. A typical detector processing system after the signal amplification is shown schematically in FIG. 13. An A/D converter can perform its function at a specific sampling rate that can be controlled by a microprocessor. The sharp high intensity noise caused by the bubbles, air-medium interface scattering or the concentration non-uniformity of a turbulent biological medium can be filtered using a filter algorithm. The filter algorithm could be a clip program that eliminating a sharp peak signal when a signal data is larger than a specific deviation. The rest data after the filter can be processed using an averaging algorithm to enhance signal to noise (S/N) ratio. An average processing such as a consecutive moving average can greatly suppress the shaking medium noise. Above filter and averaging technique is benefited by taking high sampling rate data with respect to a slow biological culture growth rate because the turbidity of the biological medium may approximately be a constant in a very short period such as in tens of seconds. In such short period, as many as hundreds of discrete data points can be acquired.

On-line calibration for the scattering method is different from the transmission method. Without a self-calibration capability in the transmission method, the scattering method requires an external standard to calibrate its measured value. As one alternative, the optical density (OD) is employed as the calibration standard for the scattering method. In a wide linear measurement range, two-point calibration should be enough for the scattering method. For measurements out its linear range, more than two point calibration is required. Generally, the relation between the concentration or the OD of biological medium and the turbidity value measured by the scattering method can be expressed using a polynomial equation. These calibration and OD conversion can be carried out using a microprocessor. The calibration may comprises steps of

making at least two set measurements on the turbidity value from the detecting apparatus and the optical density from a spectrophotometer for the biological substance with different concentration.

using the microprocessor to calculate the coefficients of a pre-defined equation based on the above measurements. The number of the measurement set should be equal to or larger than the number of the coefficients. Generally, a low order of polynomial equation can be used.

making the optical density conversion for measured turbidity based on the equation with the calculated coefficients.

While the invention has been described in conjunction with the preferred features and methods, it should be noted that many alternatives, novel combination, modifications and variations are apparent to those skilled in the art. Accordingly, the preferred embodiments and description in the invention set forth above are intended to be illustrative and not limiting. Various changes may be made without departing from the spirit and scope of the application.

1. A turbidity detecting apparatus for on-line monitoring biological substance concentration in a dynamic environment, comprising:
a container that can hold a biological liquid medium and at least a part of its wall is optically transparent.
a detecting probe mounted outside of said container comprising at least one light emission source and at least one photodetector; wherein means for the photodetector to directly detect scattered or transmitted light by the biological liquid medium in the container when the emitted light beam from the light source strikes and interacts with the liquid medium through the transparent part of the container.
an electronic module that comprising analog signal and digital data processing means for the signal from the detecting probe, and displaying related data.

2. A turbidity detecting apparatus of claim 1, wherein the detecting probe further includes a container fixture, wherein means for holding the liquid medium container firmly without any relative movement with respect to the detecting probe when the turbidity measurement is being carried out.

3. A turbidity detecting apparatus of claim 1, wherein the light emission source in the detecting probe comprising a laser diode and a focus lens to generate a light beam; wherein the photodetector is a photodiode.

4. A turbidity detecting apparatus of claim 1, wherein the electronic module includes an analog-to-digital converter, an embedded microprocessor and display unit.

5. A turbidity detecting apparatus of claim 1, wherein the electronic module includes an analog-to-digital converter and a computer.

6. A turbidity detecting apparatus of claim 1, wherein the liquid medium container for biological culture has a volume between 50 ml and 5000 ml.

7. A turbidity detecting apparatus of claim 1, wherein the medium container is an ordinary and transparent Erlenmeyer flask with a volume between 50 ml and 5000 ml.

8. A turbidity detecting apparatus of claim 1, wherein the biological substance is microorganism or cells in a biological culture broth.

9. A turbidity detecting apparatus of claim 2, wherein the dynamic environment is a biological culture environment in a biological culture incubator/shaker that including a shaking platform, an electrical motor, shaking speed control unit, and the probe is mounted on the shaking platform.

10. A turbidity detecting apparatus of claim 9, further including one or more the detecting probes and a signal relay module means for transferring signals between the multiple probes and the electronic module via wires or wireless means.

11. A turbidity detecting apparatus of claim 9, wherein the probe and the electronic module are integrated in the incubator/shaker, and wherein further includes means for controlling and regulating the shaking speed and temperature of the incubator/shaker based on measured biological substance concentration in culture broth.

12. A method for real-time and on-line monitoring biological substance concentration in a dynamic environment, that comprising the steps of
utilizing a container to hold a biological liquid medium and at least a part of wall of the container is optically transparent.
positioning a light emission source relative to the container transparent wall and irradiating light beam through and interacting with the biological medium even the medium is agitated.
positioning and aiming a photodetector to detect light from the interacting area of the biological mediu.
positioning both the light emission source and the photodetector outside of the medium container.
fixing the position of the medium container with respect to that of the light emission source and the photodetector when measurement occurs.
providing analog signal and digital data processing means to process the signal from the photodetector and evaluate the biological substance concentration.

13. A method of claim 12, wherein means for positioning and aiming the photodetector to detect the scattered light from the interacting area of the biological medium and that area is the entry or near entry area of the emission light entering the medium.

14. A method of claim 12, comprising a further step of incubating biological substance in the container.

15. A method of claim 12, further comprising means of reducing light scattering effect from air-medium interface by arranging the incident position and angle of the emitted light beam around the bottom corner of the medium container without going-through the air-medium interface.

16. A method of claim 14, wherein the dynamic environment is a biological culture environment in a biological culture incubator/shaker, and further comprising means of mounting the light emission source and the photodetector in said culture environment.

17. A method of claim 14, further comprising means of using digital signal processing algorithms such as filtering and averaging to reduce the fluctuation noise from ambient light, biomass non-uniform density distribution, bubble and air-medium interface scattering effects when the biological medium is under a continuous agitation.

18. A method of claim 12, including a further step of reducing ambient background light influence by shielding the medium container with a dark cover.

19. A method of claim 12, further including calibration and optical density conversion that comprising the steps of
making at least two set measurements on the turbidity value from the detecting apparatus and the optical density from a spectrophotometer for the biological substance with different concentration.
using the microprocessor to calculate the coefficients of a pre-defined equation based on the above measurements, wherein the number of the measurement set should be equal to or larger than the number of the coefficients.
making the optical density conversion for measured turbidity based on the equation with the calculated coefficients.

20. A method of claim 19, wherein the pre-defined equation is a low order polynomial equation.

21. A turbidity detecting apparatus for detecting biological substance concentration, comprising:
a biological liquid medium container has a volume between 50 ml and 5000 ml and at least a part of its wall is transparent.
a turbidity detecting probe mounted outside of the container comprising at least one light emission source and at least one photodetector; wherein means for the photodetector to directly detect scattered light by a biological medium in the container when the emitted light beam from the light source strikes and interacts with the biological medium.
a signal processing module for analog signal and digital data processing and display, that including an analog-to-digital converter, a digital microprocessor and a display unit.

22. A turbidity detecting apparatus of claim 21, wherein the detecting probe further including a reference photodetector and a differential photodetector electronic circuit; wherein means for compensating the emission light intensity change and the photodetector sensitivity change due to thermal drift.

23. A turbidity detecting apparatus of claim 21, further including a pulse generating circuit and a pulse gated signal detection circuit; wherein means for generating light pulse beam from the light emission source; wherein means for distinguish the signal of the photodetector between pulse-on and pulse-off.
